(19) United States
(12) Patent Application Publication
(10) Pub. No.: US 2013/0013376 A1
(43) Pub. Date: Jan. 10, 2013

(54) METHOD AND SYSTEM FOR INTERMEDIATE TO LONG-TERM FORECASTING OF ELECTRIC PRICES AND ENERGY DEMAND FOR INTEGRATED SUPPLY-SIDE ENERGY PLANNING

(75) Inventors: Jayant R. Kalagnanam, Yorktown Heights, NY (US); Dharmashankar Subramanian, Yorktown Heights, NY (US)

(73) Assignee: INTERNATIONAL BUSINESS MACHINES CORPORATION, Armonk, NY (US)

(21) Appl. No.: 13/618,907

(22) Filed: Sep. 14, 2012

Related U.S. Application Data
(62) Division of application No. 12/564,753, filed on Sep. 22, 2009.

(51) Int. Cl. G06Q 10/04

(52) U.S. Cl. 705/7.35

(57) ABSTRACT

A method of price forecasting in an electrical energy supply network and/or load (energy demand) forecasting of a given consumer of electrical energy, in the context of an electrical energy supply network that is adapted to supply electrical energy to a number consumers connected to the network. The method includes developing a multi-regime, regime switching stochastic model for determining day ahead/spot market energy prices using at least one historical profile and subjective opinion from at least one expert; and the multiple regimes correspond to a number of combinations of physical factors. A regime is identifiable by at least three factors. The method thus facilitates identifying the optimal mix of energy hedge and exposure to day ahead/spot market prices for deriving economic benefits in overall energy expenditure.

### RELATED APPLICATIONS

This application is a divisional of U.S. application Ser. No. 12/564,753, filed Sep. 22, 2009.

### BACKGROUND

Water utility companies are an example of energy consumers that face significant variability in their energy requirements. For example, under flooded conditions, due to heavy rainfall, their water pumping needs are significantly lower than they are under drought conditions. Similarly, they also face significant variability in the real-time price of electric energy which is needed to satisfy any energy demand that is exposed to the real-time market.

With respect to supply-side energy planning, large industrial/commercial energy consumers, such as water utility companies, have the following options in the energy market. They can enter into what is popularly referred to as an “energy-hedge” that is procured in the “Forward” market. Energy-hedge is a forward-looking energy-block purchase of a certain size (in Kilo/Mega Watt Hours), and spans a predetermined duration in time, at a known predetermined price. Further, over the time duration covered by the ‘energy-hedge”, any usage over and above the size of the hedge is covered by either day-ahead energy purchase market, or 15-minute-ahead-spot-purchase market. The price of electric energy in the spot-market/day-ahead-market is also subject to significant variability which depends on stress levels in the electric grid and market forces. It is in such a dynamic and uncertain context that large energy consumers need to plan on their supply-side energy planning, over the intermediate-to-long-term.

There are several forecasting models that address short-term (from days, to one week; often next-day forecasting) energy price forecasting and energy demand forecasting, spanning methods from neural networks, to statistical time-series models, stochastic processes such as jump-diffusion with mean-reversion and seasonality, regime-switching models where different underlying stochastic processes are modeled in each regime and a transition probability matrix is used to connect the regimes. The primary purpose of such models is to address operational decision-making in the utility industry such as unit-commitment, demand-management for load-shedding, etc. In short, the plethora of literature that exists on forecasting models for energy-price and demand is short-term, and is geared to address demand-side energy management.

For supply-side energy management, it is necessary to look beyond the short-term, and extend the horizon under consideration from intermediate-to-long-term (order of months, to a year). The minimum duration over which an energy-hedge may be procured for managing energy supply in the Forward market is at least one month, or more, in many deregulated markets. Such a price/load forecasting exercise, which is inherently more difficult due to the longer time-range involved, is uniquely necessitated by the supply-side energy planning problem. The state of the art is to use expert opinion about intermediate-to-long term potential price movements from niche consulting firms (such as Strategic Energy), or Financial Analyst calls hosted by investment banks. Such expert opinion is often used in conjunction with models that capture specialized stochastic processes using, for example, jump-diffusion with mean-reversion and seasonality, and the general idea of multiple regimes and transition between regimes to captures spikes. For intermediate-to-long term load forecasting, consumers use weather forecasting information, as well as in-house knowledge about the peculiarity of their historical loads.

What is needed is an analytical approach for forecasting intermediate-to-long term electric energy demand and price.

### SUMMARY OF THE INVENTION

The present invention is directed to an improved system and method applying stochastic modeling techniques for capturing intermediate-to long-term behavior of energy prices and energy demand forecasting, in order to optimize supply-side energy choices for customers.

In one aspect, there is provided a hierarchical, multi-partition, multi-regime, regime-switching, stochastic model to capture intermediate-to-long term behavior of energy prices, as well as energy demand, for optimizing supply-side energy management choices. The model can capture the peculiarity of a customer's profile. Intermediate-to-long term price and load forecasting can be combined with optimization analytics to address an optimal mix of “energy-hedge” and exposure to the day ahead/spot-market prices.

There is further disclosed a system for capturing intermediate-to-long term behavior of energy prices, and/or as energy demand where the end goal is to optimize more current supply side energy management choices for a customer.

The intermediate-to-long term price and load forecasting of the invention feeds into optimization analytics that addresses an optimal mix of energy hedge with day-ahead/spot market prices exposure.

In an embodiment there is disclosed a method of price forecasting in an electrical energy supply network and/or load (energy demand) forecasting of a given consumer of electrical energy, in the context of an electrical energy supply network that is adapted to supply electrical energy to a number consumers connected to the network, for identifying the optimal mix of energy hedge and exposure to day ahead/spot market prices for deriving economic benefits in overall energy expenditure, the method comprising;

developing a multi-regime, regime switching stochastic model for determining day ahead/spot market energy prices using at least one historical profile and an experts subjective opinion on day ahead/spot market price; and

configuring the multiple regimes to correspond to a number of combinations of physical factors;

wherein a regime is identifiable by at least three factors.

In another embodiment there is disclosed a system of price forecasting in an electrical energy supply network and/or load (energy demand) forecasting of a given consumer of electrical energy, in the context of an electrical energy supply network that is adapted to supply electrical energy to a number consumers connected to the network, for identifying the optimal mix of energy hedge and exposure to day ahead/spot market prices for deriving economic benefits in overall energy expenditure, the system comprising;

a memory;

a processor in communications with the computer memory, wherein the computer system is capable of performing a method comprising:

developing a multi-regime, regime switching stochastic model for determining day ahead/spot market energy prices using at least one historical profile and an experts subjective opinion on day ahead/spot market price; and

configuring the multiple regimes to correspond to a number of combinations of physical factors;

wherein a regime is identifiable by at least three factors.

In still another embodiment there is disclosed a computer program product for price forecasting in an electrical energy supply network and/or load (energy demand) forecasting of a given consumer of electrical energy, in the context of an electrical energy supply network that is adapted to supply electrical energy to a number consumers connected to the network, the computer program product comprising:

a storage medium readable by a processing circuit and storing instructions for processing by the processing circuit for performing a method comprising:
providing a multi-regime, regime switching stochastic model for determining day ahead/spot market energy prices using at least one historical profile and an experts subjective opinion on day ahead/spot market price; and
configuring the multiple regimes to correspond to a number of combinations of physical factors;
wherein a regime is identifiable by at least three factors.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the conception and specific embodiment as a base for designing or modifying the structures for carrying out the same purposes of the present invention and that such other features do not depart from the spirit and scope of the invention in its broadest form.

### BRIEF DESCRIPTION OF THE DRAWINGS

For a more complete understanding of the present invention and the advantages thereof, reference is now made to the following description taken in conjunction with the accompanying Drawings in which:

FIG. 1 shows an example of a hierarchical partitioning of a horizon;

FIG. 2 shows a Multi-Regime, Regime-Switching Stochastic model in accordance with the principles of the invention;

FIG. 3 shows a probability distribution of an electrical load during a base peak period;

FIG. 4 shows a probability distribution of an electrical load during a low stress peak period;

FIG. 5 shows a probability distribution of an electrical load during a medium stress peak period;

FIG. 6 shows a probability distribution of an electrical load during a severe stress peak period;

FIG. 7 shows a sample of real time price and load data during August, 2006;

FIG. 8 shows a sample of real time price and load data during March/April, 2007;

FIG. 9 is a flow chart of the Forward issue;

FIG. 10 is flow chart of the Inverse issue; and

FIG. 11 is a block diagram of a computer system for use with the present invention.

### DETAILED DESCRIPTION

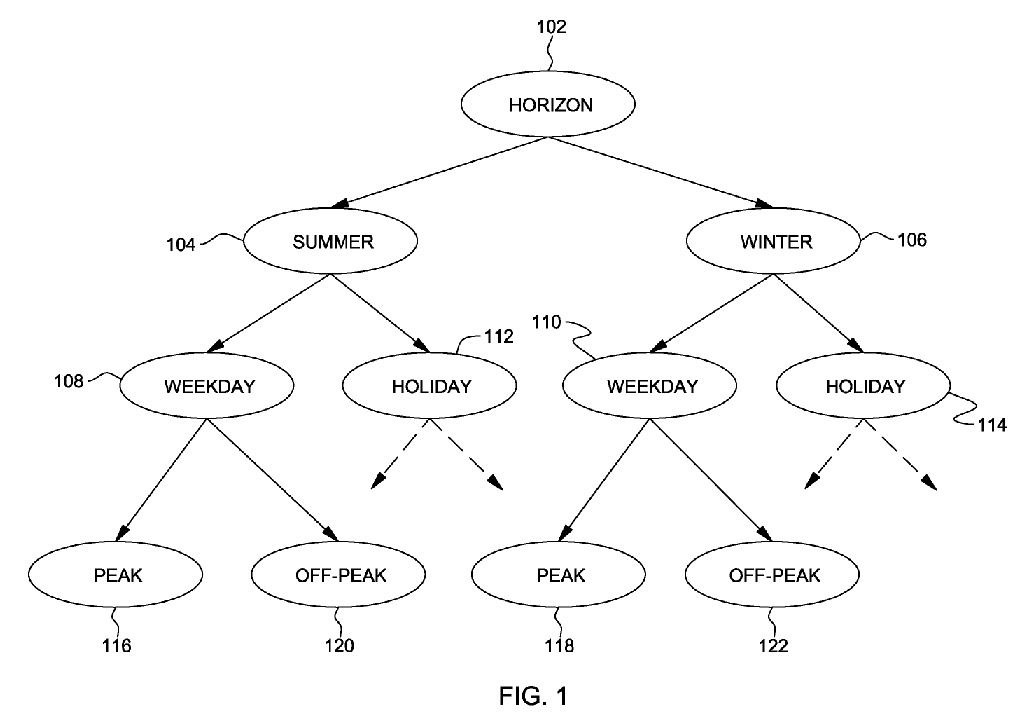

Initially a hierarchical partitioning scheme of a horizon under forecasting consideration is developed. This partitioning may be motivated by a combination of physical factors that drive variability in the quantity being forecast such as, for example, electric energy price or load. An example of physical factors that drive variability can be a season combined with a time of day, and with a type of day, such as weekday or weekend. An example of hierarchical partitioning of the horizon is shown in FIG. 1.

In FIG. 1, the forecasting horizon 102 in set to an hourly resolution of electric energy spot-market hourly price in $/MWH. The hours of the horizon partition are set to summer hours 104 and winter hours 106, for example, at a top-most level. This is an example of a seasonal partitioning. Further, at a second layer in the hierarchy, the summer/winter hours are further partition into weekday hours 108, 110 and weekend/holiday hours 112, 114. This is an example of partitioning motivated by peculiar physical factor of higher volume commercial activity, hence energy consumption, in weekdays versus relatively lower volume of commercial activity, and energy consumption, in weekends or holidays. Furthermore, at a third layer of the hierarchy, the hours are partition into peak hours, 116/118, and off-peak hours, 120, 122. This is again an example of context specific partitioning, because peak-hour usage of electric energy is much higher than off-peak hour usage, and electric prices exhibit a different behavior. Each leaf-node in the hierarchical tree of FIG. 1 corresponds to one specific partition of a forecasting horizon, with a specific combination, such as Summer-Weekday-Peak-hours.

For notational convenience, a contiguous set of time buckets is considered which corresponds to an ordered set of hourly time indices, {1 . . . T}, where T is the number of hours in the forecasting duration and every hourly time index, t, belongs to exactly one leaf-node partition. The set of leaf-node partitions are denoted with an index set, {1, . . . , I}, where I is the total number of partitions. Further, Π(t) denotes one-to-one mapping, from index set {1 . . . T} to index set, {1, . . . , I}.

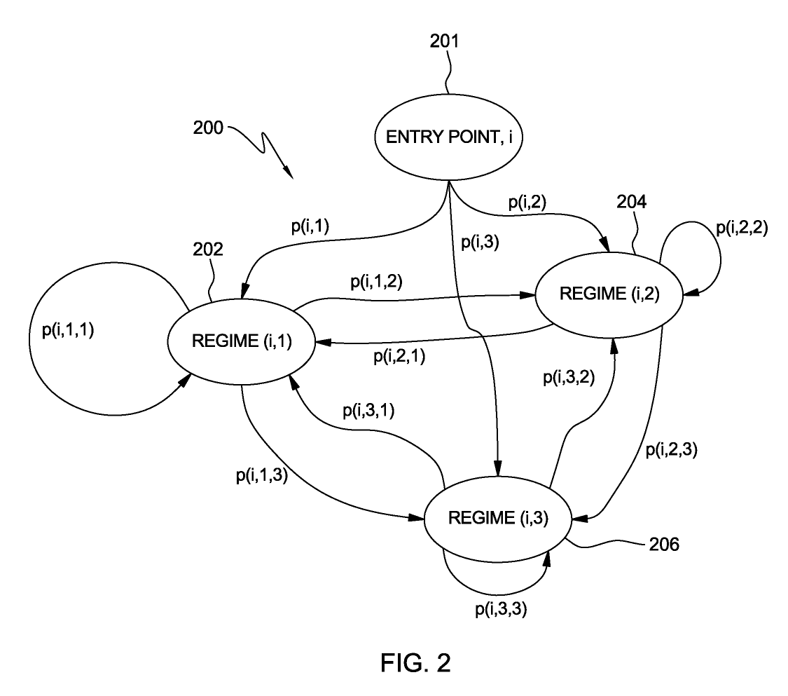

Each of the leaf nodes in the hierarchical partition of the forecasting horizon, for example, the partition that corresponds to the combination Summer-Weekday-Peak-hours, is then modeled in the form of a multi-regime, regime-switching stochastic model 200 in FIG. 2. FIG. 2 shows a multi-regime, regime-switching stochastic model for any given leaf node, e.g., partition index, i. This example has 3 regimes for partition index, i, and these are denoted by nodes labeled, Regime(i,1), 202; Regime(i,2), 204; and Regime(i,3), 206. Within each regime, inside each partition, the quantity is modeled as a probability distribution, which, upon being sampled yields a possible value for the quantity. The node labeled “Entry Point, i”, 201, is entry into the partition, when time progresses into partition index, i. The earliest such time index is at time point, t=min{t:Π(t)=i}, beyond which, such a transfer into partition index, i, happens for all time indices, τ, such that,

(1<τ≦T:Π(τ−1)≠i,Π(τ)=i).

Upon entry into partition index, i, at some time index, say t, the quantity being forecasted moves into some one regime, out of for example, Regime(i, 1), 202, Regime(i, 2), 204 or Regime(i, 3), 206 as determined by probabilities p(i,1), p(i,2) and p(i,3) respectively. In general, if partition index, i, has NRᵢ distinct regimes, the quantity being forecasted moves into one of the NRᵢ regimes, namely, the set, {Regime(i,1), . . . , Regime(i,NRᵢ)}, as determined by initial regime probabilities, p(i,1), . . . , p(i,NRᵢ). For all pairs of time indices (t₁, t₂) in partition, i, i.e. Π(t₁)=Π(t₂)=i, if the quantity is in the j^{th} regime, Regime(i,j) at time, t₁, then it will transition into the k^{th} regime, Regime(i,k) at time t₂, with intra-partition-inter-regime transition probability, p(i,j,k), as shown in FIG. 2.

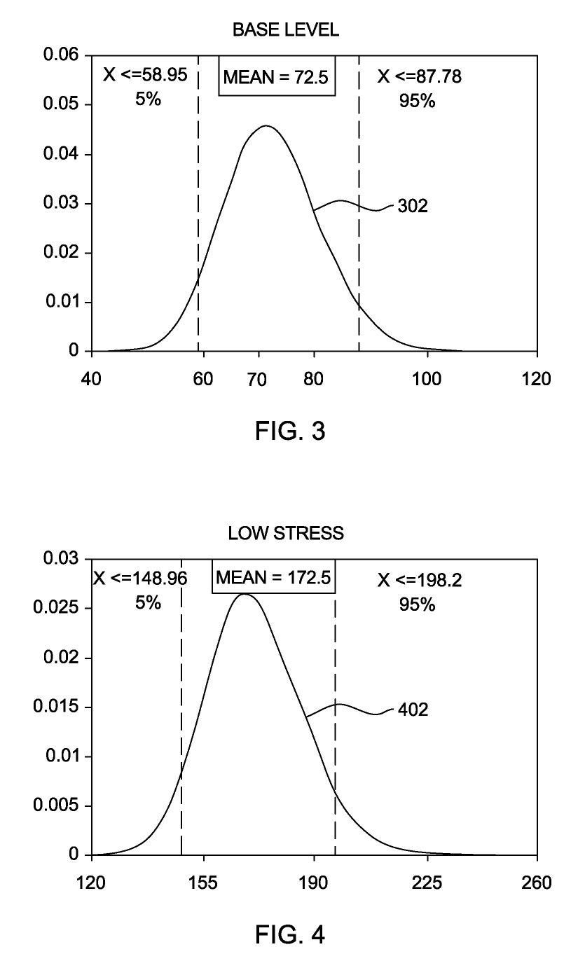

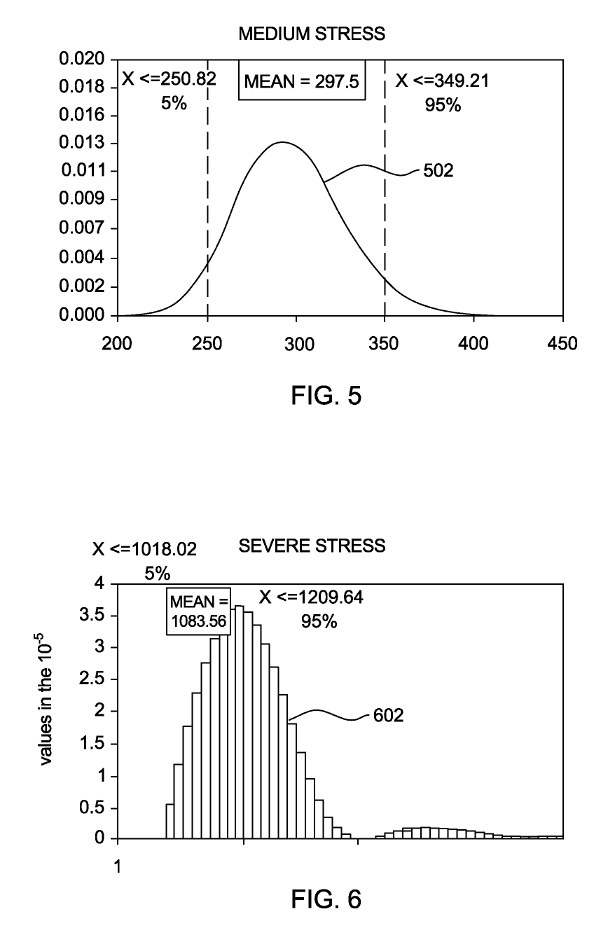

An assessment of the peculiarity of a consumer profile is carried out using historical profiles as well as expert input from in-house experts and/or outside consultants. The number of regimes corresponds to the number of combinations of key physical factors that can drive variability. Each of four regimes further identified in FIGS. 3, 4, 5 and 6 is shown as an appropriate probability distribution, and the transitions between various regimes can be captured using jump-probabilities. FIG. 3 shows an appropriate probability base level distribution 302 of electrical load; FIG. 4 shows an appropriate probability low stress distribution 402 of electrical load; FIG. 5 shows an appropriate probability medium stress distribution 502 of electrical load; and FIG. 6 shows an appropriate probability severe stress distribution 602 of electrical load.

In FIGS. 3-6, the x-axis is the domain, or support, over which the stochastic quantity, namely, Price, $/MWH, varies in each of the illustrated regimes shown in FIGS. 3-6. The y-axis shows the probability density in the case of continuous variability, and probability mass function in the case of discrete variability, because each Fig. is a probability distribution. The variability over the support, i.e., the domain of possible values, can be continuous or discrete.

Regime specific probability distributions and inter-regime jump probabilities are estimated using a combination of historical data and expert opinion. Time wise correlations can also be included in the model for the same quantity, e.g., day ahead price/spot price, to capture a correlation that may exist in time. The advantage is that such a multi-regime, regime-switching, stochastic model can capture closely a real time, wide variability in prices and loads in a mathematical model, which can then be used in planning analytics to identify an optimal mix of energy hedge and day ahead/spot market prices, to derive significant economic benefits in overall energy expenditure.

In the stochastic modeling scheme disclosed, stochastic behavior of a volatile quantity can be mathematically described using appropriate probability distributions such as real time price and day ahead price, both of which are very volatile qualities and which exhibit distinct behavior that depends on time of use, seasonal information and stress conditions in the grid.

In one embodiment, three physical factors that drive price variables can include:

1) Time of use-peak time vs. off peak time;

2) Seasonal information-summer vs. winter; and

3) Stressful conditions in the grid—high stress due to excessive peak demand, extreme market factors, extreme weather vs. moderate/low stress conditions, etc.

Any combination of the above three factors (and possibly other factors) will lead to a specific regime, such as, for example: a High Stress Condition, in Summer, with Peak-Time usage. This regime will have a distinct scale, location (magnitude) and shape, when described using probability distributions. Obviously a single probability distribution cannot adequately capture the complex volatility of Real Time Price/Day Ahead Price.

For determining a future (ahead) price the multi-regime stochastic model distinguishes between the various regimes in which the real time price/day ahead price can exist. The model mathematically captures the stochastic behavior in each regime, using appropriate probability distributions where the distributions are obtained by using a combination of historical behavior and one or more expert opinions. The model can also capture relevant switching/transitioning between various regimes which are in line with historical observations and expert opinions. The model can also capture temporal correlation between Day-Ahead Price and Real Time Price and, if applicable, a Load.

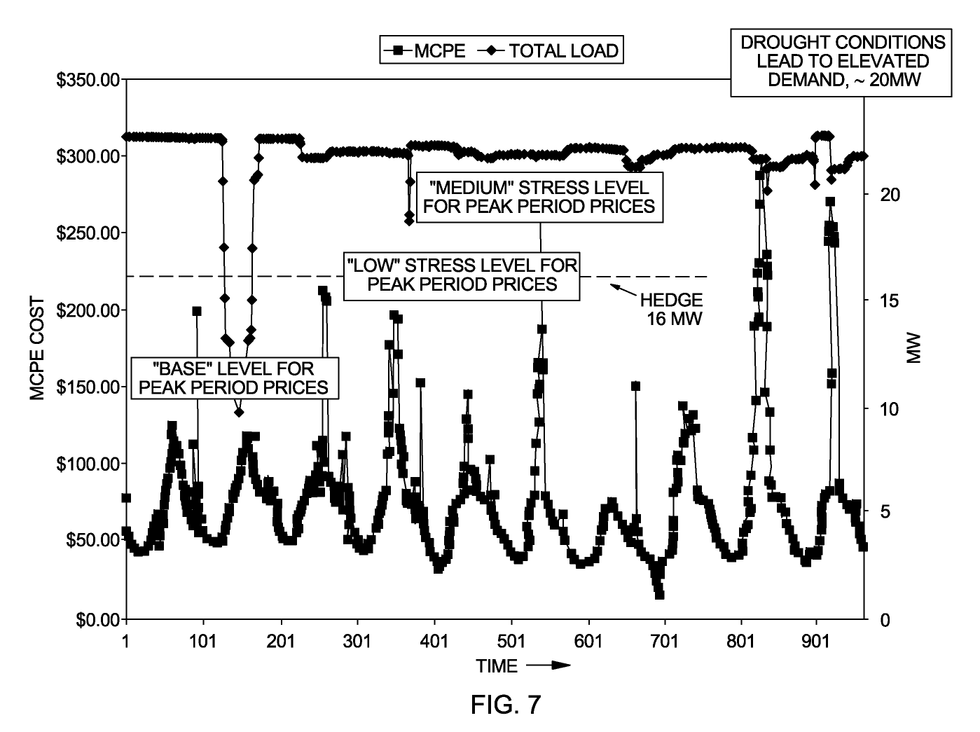

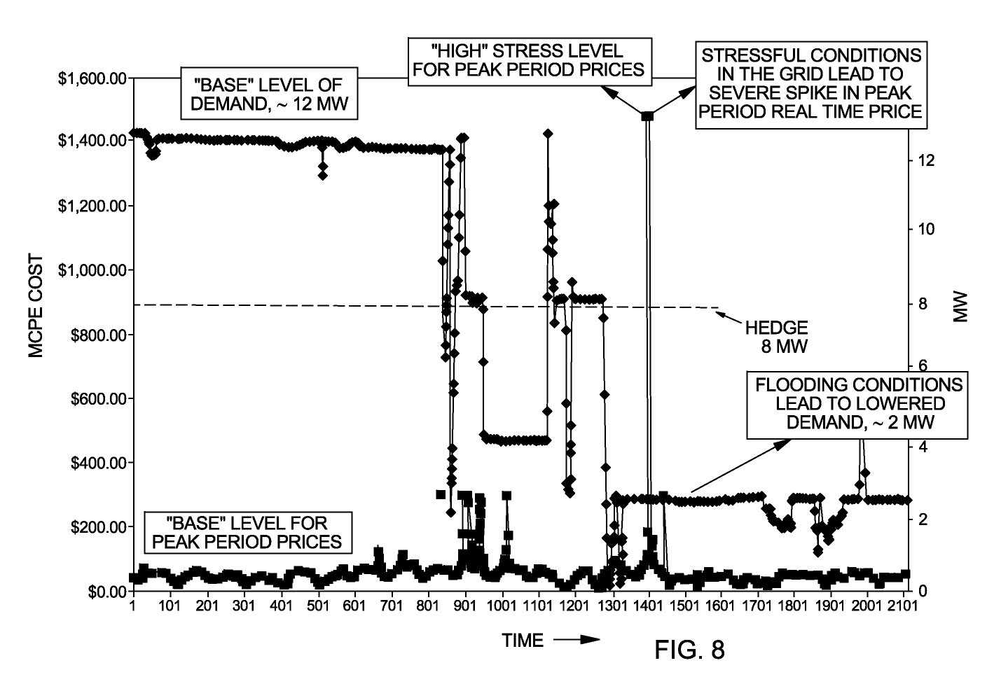

Referring to FIGS. 7 and 8, there are shown examples of real time price data for August 2006 and March/April 2007. From these Figs., the peak period real time price profile exhibits the following regimes:

A normal regime that is in the range of 75-100 $/MWH;

A relatively low stress regime that is in the range of 150-250 $/MWH;

A relatively moderate stress regime that is in the range of 250-350 $/MWH; and

A relatively High stress regime that is in the range of 1000-1500 $/MWH.

Referring to FIG. 2 which shows a multi-regime, regime switching stochastic model, each regime 202, 204 and 206 is depicted by a probability distribution of electrical load where FIG. 3 is an example of a base level probability distribution 302 having a mean value of substantially 72.5 $/MWH. FIG. 4 shows a low stress probability distribution 402 having an example mean value of substantially 172.5 $/MWH; FIG. 5 shows a medium stress probability distribution 502 having an example mean value of substantially 297.5 $/MWH; and FIG. 6 shows a high stress where probability distribution 602 has an example mean value of substantially 1083.56 $/MWH. Each of the probability distribution curves is obtained by using historical observations (data) and at least one expert's subjective opinion on day ahead/spot market price so that each model depicts reality and is useful for planning analytics.

Similar regime-specific stochastic modeling can be performed for the energy load profile where the demand (or Energy Load in MegaWatts per Hour) profile also shows volatility due to Weather related conditions such as flood/drought conditions, and the time of use, such as a season, etc.

Careful examination of data, annotated with physical causes, will reveal various regimes such as is shown in FIG. 8, where demand shows at least three regimes as follows:

Base regime around 12 MW;

Low regime around 2 MW (flooding conditions); and

High regime around 20-22 MW (drought conditions).

Many historical data sets over multiple prior years, as relevant, may be used to estimate the various parameters.

Following is a description of calculations for characterizing different regimes in each partition, as well as an estimation of a probability distribution that is embedded in each regime. It should be noted that upon transitioning into a regime, the quantity assumes a value that is sampled from the probability distribution embedded within that regime. The number of distinct regimes in each partition, say, partition index, i, is determined using a historical data set for price/load, say denoted by Q, assembled over multiple relevant years, {1 . . . Y}. Let T_{y} denote the number of hourly time-buckets in a historical data-set for year, y. Note that the ordered set of time-indices, {1 . . . T_{y}}, may be used to index time in year, y. For each partition, i, the following steps are performed:
1. Assemble specific data subset, Q_{i,y} for each year, y, and let

$${Q}_{i} = {⋃}_{\{ 1 … Y \}} {Q}_{i , y} .$$

### (Note:

$$Q = {⋃}_{\{ 1 … I \}} {Q}_{i} ) .$$

2. Sort the set, Qᵢ, in ascending order, and compute the percentile ranks for each data point, qᵢεQᵢ.
3. The number of regimes, NRᵢ, in each partition index, i, is a flexible user-controlled parameter, depending on the specifics of the data set and context. An example choice is a triaging, where a user picks three regimes, namely, Low, Medium and High. The sorted historical data set, Qᵢ, is partitioned into NRᵢ number of intervals using user-defined (NRᵢ−1) split points on the percentile-rank scale, in order to demarcate the NRᵢ regimes in the historical data-set. For example, the user picks the 33.33^{th} percentile and the 66.66^{th} percentile as the split points that demarcate Low, Medium and High. An expert user may choose an appropriate set of split points, in line with, for example, an annotated physical interpretation of the historical data set.
4. Using the above-obtained historical data in each of the NRᵢ splits from Step 3, a probability distribution using standard statistical estimation techniques for the quantity, is fit into each interval (within each partition, i), where \tilde{ρ}(i,j) denote the resulting probability distribution that describes the variability of the quantity in partition index, i, and regime, jε{1, . . . , NRᵢ}.

Note that Step 3 also establishes mapping, ω: q_{i,y}εQ_{i,y}→{1 . . . NRᵢ}, for individual data-points, q_{i,y}, in each partition, i, and in each historical year, y.

Step 4 can further be extended to allow expert-input based updating of the probability distributions, \tilde{ρ}(i,j). Such expert inputs may be derived from future outlook calls hosted by investment banks, or industry-specific, niche-consulting firms and researchers.

For each partition, the probability parameters is estimated. For partition index, i, historical data is used to estimate the initial regime probabilities, namely, p(i,1), . . . , p(i,NRᵢ), as well as the intra-partition-inter-regime transition probabilities {p(i,j,k): j, kε{1 . . . NRᵢ}}. A frequentist probability calculation may be used to arrive at an estimate of the above probabilities. Specifically, consider a subset of the data that corresponds to partition index, i, in each historical year, yε{1 . . . Y}. Let T_{i,y} stand for the set of all time indices (time points) that belong to this specific data subset corresponding to partition index, i, and year, y, i.e., Π(t)=i,∀tεT_{i,y}. Let I_{t,i,y,j} be the indicator function that takes on a value, 1, if time index, t, in the above set T_{i,y}, has a historical price/load value that belongs to the j^{th} regime, Regime(i,j), in partition index, i, and year, y.

In other words:

If ω(q_{t,i,y})=j, where, tεT_{i,y},iε{1 . . . I},yε{1 . . . Y},

I_{t,i,j,k}=1

Else, I_{t,i,j,k}=0

The initial regime probabilities in partition, i, may be estimated as:

$$p ( i , j ) = \frac{{\sum }_{y = 1}^{Y} {\sum }_{t = 1}^{{T}_{i}} {I}_{t , i , y , j}}{{\sum }_{y = 1}^{Y} \vert {T}_{i , y} \vert} ,$$

∀jε{1, . . . , NR(i)},
where the operator, ∥, in the denominator stands for the cardinality operator.

Similarly, let T_{i,y,j} stand for the set of all time indices (time points) that belong to the specific data subset corresponding to partition index, i, and year, y, i.e.,

∀tεT_{i,y,j}:Π(t)=i, AND ω(q_{t,i,y})=j

Let I_{t,i,y,j,k} be the indicator function that takes on a value, 1, if it satisfies two conditions where:

1. Time index, t, in the above set T_{i,y,j}, has a historical price/load value, q_{t,i,y} that belongs to the j^{th} regime, Regime(i,j), in partition index, i, and year, y, and,

2. Time index, t+1, i.e. the immediately next consecutive time index, belongs to the ordered set {1 . . . T_{y}}, falls in the same partition, i, and has a historical price/load value, q_{t+1,i,y} that belongs to the k^{th} regime, Regime(i,k), in partition index, i, and year, y. (Note that time index, t+1, may or may not belong to set T_{i,y,j}).

In other words:

If ω(q_{t,i,y})=j,Π(t+1)=i, AND ω(q_{t+1,i,y})=k,

where, tεT_{i,y,j}, t+1ε{1 . . . T_{y}}, iε{1 . . . I}, yε{1 . . . Y},

Then, I_{t,i,j,k}=1

Else I_{t,i,j,k}=0

Then, the intra-partition, inter-regime transition probabilities may be estimated as:

$$p ( i , j , k ) = \frac{{\sum }_{y = 1}^{Y} {\sum }_{t = 1}^{{T}_{i}} {I}_{t , i , y , j , k}}{{\sum }_{y = 1}^{Y} \vert {T}_{i , y} \vert} ,$$

∀j,kε{1, . . . , NR(i)},
where the operator, ∥, in the denominator stands for the cardinality operator.

For the above estimates of both the initial regime probabilities, and the intra-partition, inter-regime transition probabilities may be further modified and updated with expert-inputs. Such expert inputs may be derived from future outlook calls hosted by investment banks, or industry-specific, niche-consulting firms and researchers.

The Hierarchical Multi-Partition, Multi-Regime, Stochastic Regime-Switching Forecasting Algorithm for generating a stochastic time-profile of price/load over the forecasting duration indexed by the set, {1 . . . T}, proceeds as follows:
0. Set t=0, and the initialize the mapping, Ω: tε{1 . . . T}→jε{1 . . . NR_{Π}(t)}, to an empty, null map. Note that Ω contains the identity of the regime, from the set {1 . . . NR_{Π(t)}}, occupied by the quantity, in partition index, Π(t) at time, t. This mapping will get updated as the system evolves in the stochastic model. Also, initialize the map, Σ:tε{1 . . . T}→, to an empty, null map. Note that Σ contains the forecast of the quantity, and will get updated as the system evolves in the stochastic model.
1. Assemble a historical data set, Q, over as many multiple relevant years as needed, say, {1 . . . Y}.
2. Compute estimates for all necessary parameters as per the detailed description in the preceding paragraphs A-A, A-A. Specifically, compute and characterize:
   a. the number of hierarchical partitions in index set {1 . . . I} and mapping Π,
   b. the number of regimes, NRᵢ, in each partition, i, the probability distribution, \tilde{ρ}(i,j), which describes the variability of the quantity in partition index, i, and regime, jε{1, . . . , NRᵢ}, and the mapping ω: q_{i,y}εQ_{i,y}→{1 . . . NRᵢ}, for individual data-points, q_{i,y}, in each partition, i, and in each historical year, y,
   c. the initial regime probabilities, namely, p(i, 1), . . . , p(i, NRᵢ), as well as intra-partition, inter-regime transition probabilities {p(i,j,k): j,kε{1 . . . NRᵢ}}, for each partition index, i.
3. Set t=t+1.

If t>T,

Go to Step 6.
Else Go to Step 4.
4. Compute partition identity, i, of time index, t, using i=Π(t).
If t>1 and i=Π(t−1):

Perform a stochastic transition from regime Ω(t−1) to some regime, kε{1 . . . NRᵢ}, depending on the probabilities, {p(i,Ω(t−1),k):j,kε{1 . . . NRᵢ}}. Say, this stochastic transition, within partition, i, takes the quantity to regime, kₜε{1 . . . NRᵢ}. Update map, Ω, by setting, Ω(t)=kₜ. Sample a value, say, r_{i,k}_{ₜ} from the probability distribution, \tilde{ρ}(i,kₜ), and update the map, Σ(t)=r_{i,k}_{ₜ}.

Go back to Step 3.

### Else Go to Step 5.

5. Perform a stochastic transition to some initial regime, kε{1 . . . NRᵢ}, in partition index, i (computed in Step 4), as per the initial regime probabilities, p (i,1), . . . , p(i, NRᵢ). Say, this stochastic transition, into partition, i, takes the quantity to regime, kₜε{1 . . . NRᵢ}. Update the map, Ω, by setting, Ω(t)=kₜ. Sample a value, say, r_{i,k}_{ₜ} from the probability distribution, \tilde{ρ}(i,kₜ), and update the map, Σ(t)=r_{i,k}_{ₜ}.
   Go back to Step 3.
6. The resulting map, Σ, contains a sample path for the forecast of the quantity, over the duration, {1 . . . T}.

Repeating Steps 0-6 will generate another sample path, and so on. In steps 0-6, the system progresses across consecutive time indices in the horizon index set {1 . . . T}, by transitioning stochastically from regime to regime (both, across partitions and within the same partition, depending on the time index), and the resulting time-profile of the quantity represents a forecast in the form of a sample path. Any such sample path is a representative time-profile that captures the essential behavior of the price/load across the variability of different seasons, peak/off-peak periods and other physical factors that lead to different regimes in the magnitude of price/load, across the forecasting duration. The sample path may be used for optimal supply-side procurement planning analytics. In fact, the optimal supply-side procurement planning analysis may be carried out against multiple such sample paths to gain insights into the best set of forward-looking procurement contracts.

The model disclosed can be used to address a forward issue and an inverse issue. The forward issue is where a risk quantification of the overall energy cost over a chosen horizon of interest is obtained. The inverse issue addresses the stochastic optimization question. Prior to addressing the forward and inverse issues, the functions of steps used in generating the model are addressed as follows:

### Step 1:

Assemble a historical data set of, for example a prior time range, e.g., 2-4 years, of price/load data.

The user decides the resolution/time bucket at which to distinguish the volatility of the price/load of, for example, monthly, or by the season where each month of season will have a parametrically distinct volatility model.

For each of the above time buckets, for example, month or season.

Identify the number of distinct regimes in which the volatile quantity of interest may realize itself, in that time bucket.

Cluster algorithms that identify and enumerate the number of statistically significant clusters can be used as a starting point to generate an initial set of data determined clusters, each of which is a regime.

This initial set can be augmented with additional regimes, as suggested by visual, or expert examination of data and its annotations. In one example, the resolution may be a monthly distinction of price volatility.

For August 2006 (FIG. 7), or March/April 2007(FIG. 8).

The peak period real time price profile exhibits the following regimes:

A normal regime in the 75-100 $/MWH;

A relatively low stress regime in the 150-250 $/MWH;

A relatively moderate stress regime in the 250-350 $/MWH; and

A relatively high stress regime in the 100-1500 $/MWH.

### Step 2:

For each regime, within each time bucket (for example, month/season, etc. which is the users choice):

Fit a probability distribution over the range of historical values that fall in the said regime;

Estimate the transition probability matrix over the cross product of the set of regimes for each time bucket;

The transition probability matrix for any time bucket models the step wise probability of transition from regime I, in any hourly time index t, to regime j, in the subsequent hourly time index t+1, for all regimes (I,j), and for all hourly time indices t, within that time bucket.

In one embodiment, the above fitting procedures for the probability distribution, and the transition probability matrix is performed using a minimization of squared error criterion.

### Step 3:

The forward issue—addressing the risk quantification question.

For price: Simulate the corresponding multi-regime, regime-switching stochastic model, computed in step 2 above, for one year (or any time horizon of interest) in order to generate a sample set of, for example, 10,000 samples.

Each sample in this set is a time-profile of price over the horizon of interest.

In addition, the following information is utilized, if available;

A set of hedge contracts, over the above horizon, together with the purchase price, and sell-back logic for the unused energy, and

The energy cost calculation logic.

Step 3 uses a simulated sample set of load and price profiles to compute as an output the overall energy expenditure distribution, and quantify the risk of exceeding any user defined known threshold (tolerance level).

### Step 4:

The inverse issue—addressing the Optimal Selection of Energy Hedge.

The inverse issue addresses the stochastic optimization question.

A candidate set of Energy Hedge Blocks along with business constraints such a minimum block size, minimum duration of purchase, etc., if available, and Energy cost calculation logic.

Step 4 uses the simulated sample set of load/price profiles from step 3 and the above inputs to compute an optimal set of Hedge Blocks with size and duration of coverage; and Real time and Day Ahead exposure that is recommended with the above Hedge Solution; where the Overall Energy Expenditure Distribution has an acceptable risk of exceeding a user defined known threshold (tolerance level). Step 4 uses stochastic mathematical programming techniques to solve this problem.

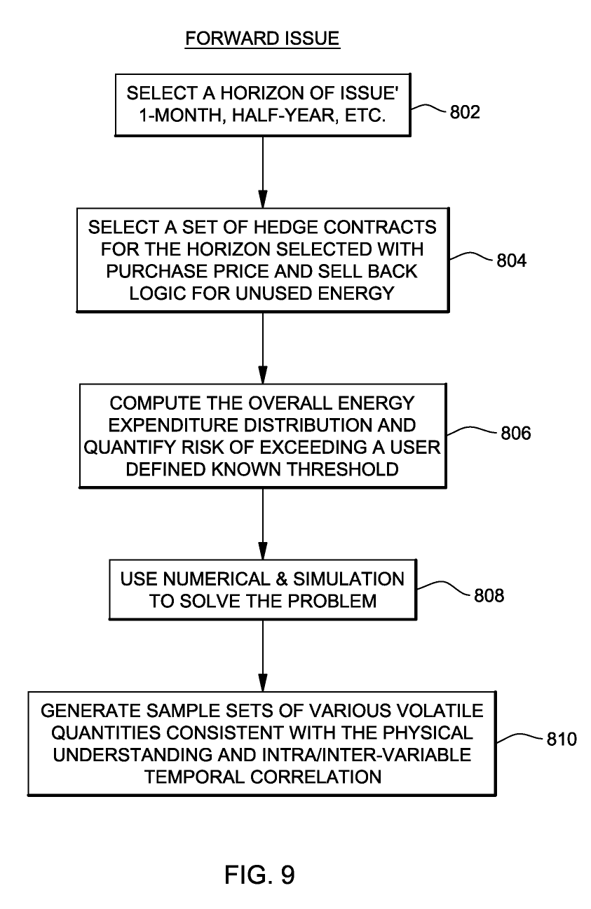

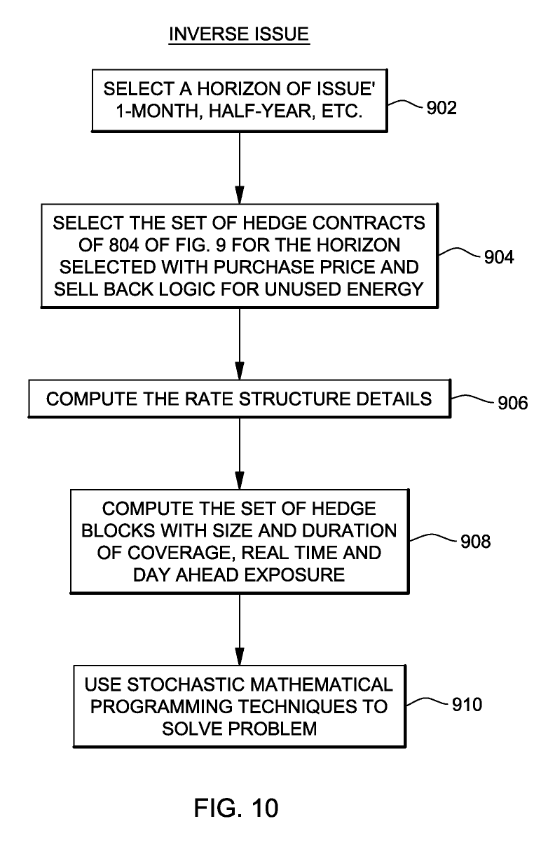

Referring to FIG. 9, there is shown a flow chart 800 implementing the method steps for performing the forward issue.

The day ahead price and load is a first step towards addressing the forward problem. Initially a horizon of a time period of one month, a half year etc. is selected at 802. Then a set of hedge contracts for the horizon select and the purchase price and sell back logic for unused energy is provided at 804. The information above describes regime switching stochastic models for real time price, day ahead price, and load pertinent to the horizon rate structure details. From this information, at 806, compute the overall energy expenditure distribution and quantify the risk of exceeding any user defined known threshold. Then, at 808, numerical & simulation techniques are used to solve this problem. With this information, at 810, sample sets of various volatile quantities that are consistent with the physical understanding and intra-/inter-variable temporal correlation are generated.

Referring to FIG. 10, there is shown a flow chart 900 depicting method steps for performing the inverse issue.

The inverse issue addresses the stochastic optimization question of, What is the optimal hedge sizing for the fixed price purchase component? Initially a horizon of a time period of one month, a half year etc. is selected at 902. Then, at 904, the set of hedge contracts for the horizon select and the purchase price and sell back logic for unused energy selected for 804 in FIG. 9 is provided at 904. At 906 the rate structure details; the candidate set of energy hedge blocks along with business constraints such as minimum block size, minimum duration of purchase, etc. are computed. At 908, the set of hedge blocks with size and duration of coverage, real time and day ahead exposure that is recommended with the above hedge solution such that the overall energy expenditure distribution has an acceptable risk of exceeding a user defined known threshold tolerance level is obtained. Then, at 910 the function uses stochastic mathematical programming techniques to solve the problem.

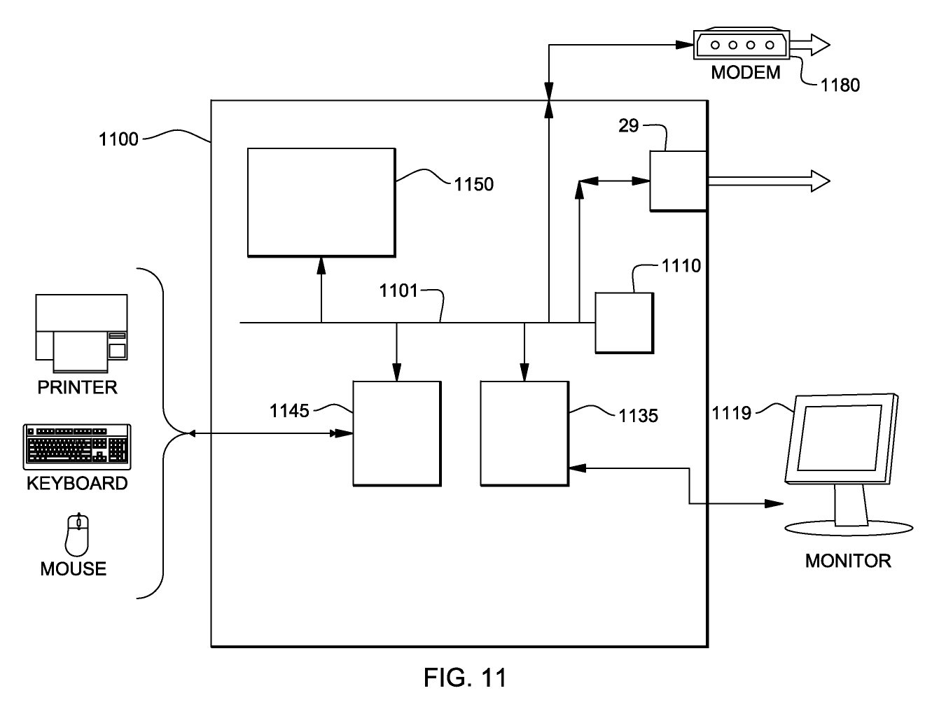

A computer-based system 1100 is depicted in FIG. 11 herein by which the method of the present invention may be carried out. Computer system 1100 includes a processing unit, which houses a processor, memory and other systems components that implement a general purpose processing system or computer that may process a computer program product. The computer program product may comprise media, for example a compact storage medium such as a compact disc, which may be read by the processing unit through a disc drive, or by any means known to the skilled artisan for providing the computer program product to the general purpose processing system for processing thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (as mentioned) or may be located on a remote system such as a server (not shown), coupled to processing unit, via a network interface such as an Ethernet interface. Monitor, mouse and keyboard are coupled to the processing unit, to provide user interaction. Printer is shown coupled to the processing unit via a network connection, but may be coupled directly to the processing unit.

More specifically, as shown in FIG. 11, the computer system 1100, includes one or more processors or processing units 1110, a system memory 1150, and an address/data bus structure 1101 that connects various system components together. For instance, the bus 1101 connects the processor 1110 to the system memory 1150. The bus 1101 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. Additionally, the computer system 1100 includes one or more monitors 19 and, operator input devices such as a keyboard, and a pointing device (e.g., a “mouse”) for entering commands and information into computer, data storage devices, and implements an operating system such as Linux, various Unix, Macintosh, MS Windows OS, or others.

The computing system 1100 additionally includes: computer readable media, including a variety of types of volatile and non-volatile media, each of which can be removable or non-removable. For example, system memory 1150 includes computer readable media in the form of volatile memory, such as random access memory (RAM), and non-volatile memory, such as read only memory (ROM). The ROM may include an input/output system (BIOS) that contains the basic routines that help to transfer information between elements within computer device 1100, such as during start-up. The RAM component typically contains data and/or program modules in a form that can be quickly accessed by processing unit. Other kinds of computer storage media include a hard disk drive (not shown) for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. Any hard disk drive, magnetic disk drive, and optical disk drive would be connected to the system bus 1101 by one or more data media interfaces (not shown). Alternatively, the hard disk drive, magnetic disk drive, and optical disk drive can be connected to the system bus 1101 by a SCSI interface (not shown), or other coupling mechanism. Although not shown, the computer 1100 can include other types of computer readable media. Generally, the above-identified computer readable media provide non-volatile storage of computer readable instructions, data structures, program modules, and other data for use by computer 500. For instance, the readable media can store an operating system (O/S), one or more application programs, such as video editing client software applications, and/or other program modules and program data for enabling video editing operations via Graphical User Interface (GUI),Input/output interfaces 1145 are provided that couple the input devices to the processing unit 1110. More generally, input devices can be coupled to the computer 1100 through any kind of interface and bus structures, such as a parallel port, serial port, universal serial bus (USB) port, etc. The computer environment 1100 also includes the display device 1119 and a video adapter card 1135 that couples the display device 1119 to the bus 1101. In addition to the display device 19, the computer environment 1100 can include other output peripheral devices, such as speakers (not shown), a printer, etc. I/O interfaces 1145 are used to couple these other output devices to the computer 1100.

As mentioned, computer system 1100 is adapted to operate in a networked environment using logical connections to one or more computers, such as a server device that may include all of the features discussed above with respect to computer device 1100, or some subset thereof. It is understood that any type of network can be used to couple the computer system 1100 with server device, such as a local area network (LAN), or a wide area network (WAN) (such as the Internet). When implemented in a LAN networking environment, the computer 1100 connects to local network via a network interface or adapter 29.

When implemented in a WAN networking environment, the computer 1100 connects to a WAN via a high speed cable/dsl modem 580 or some other connection means. The cable/dsl modem 1180 can be located internal or external to computer 1100, and can be connected to the bus 1101 via the I/O interfaces 1145 or other appropriate coupling mechanism. Although not illustrated, the computing environment 1100 can provide wireless communication functionality for connecting computer 1100 with remote computing device, e.g., an application server (e.g., via modulated radio signals, modulated infrared signals, etc.).

Although an example of the present invention has been shown and described, it would be appreciated by those skilled in the art that changes might be made in the embodiment without departing from the principles and spirit of the invention, the scope of which is defined in the claims and their equivalents.

What is claimed is:

1. A method of price forecasting in an electrical energy supply network and/or load (energy demand) forecasting of a given consumer of electrical energy, in the context of an electrical energy supply network that is adapted to supply electrical energy to a number consumers connected to the network, for identifying the optimal mix of energy hedge and exposure to day ahead/spot market prices for deriving economic benefits in overall energy expenditure, the method comprising;
selecting a time frame of at least one month;
selecting a set of hedge contracts for the time frame of at least one month with purchase price and sell back logic for unused energy;
computing, using the time frame and hedge contract selections, the overall energy expenditure distribution and quantify risk of exceeding a user defined known threshold;
applying numerical and simulation techniques to obtain a solution; and
generating, using said the obtained solution, sample sets of various volatile quantities consistent with the physical understanding and intra-/inter-variable temporal correlation,
wherein a program using a processor unit runs one or more of said selecting a time frame, selecting a set of hedge contracts, computing, applying and generating steps.

2. A method of price forecasting in an electrical energy supply network and/or load (energy demand) forecasting of a given consumer of electrical energy, in the context of an electrical energy supply network that is adapted to supply electrical energy to a number consumers connected to the network, for identifying the optimal mix of energy hedge and exposure to day ahead/spot market prices for deriving economic benefits in overall energy expenditure, the method comprising;
selecting a time frame of at least one month;
selecting a set of hedge contracts for the time frame of at least one month with purchase price and sell back logic for unused energy;
computing, based on the selections, rate structure details, and candidate set of energy hedge blocks along with minimum block size and minimum duration of purchase;
computing a set of hedge blocks with size and duration of coverage and real time and day ahead exposure using the result of the above computing; and
using stochastic mathematical programming techniques for obtaining a result,
wherein a program using a processor unit runs one or more of said selecting a time frame, selecting a set of hedge contracts, using, computing, and using stochastic mathematical programming techniques steps.
